(19) United States
(12) Patent Application Publication
(10) Pub. No.: US 2025/0277632 A1
(43) Pub. Date: Sep. 4, 2025

(54) SEALS AND FLOW RESTRICTORS FOR ROTARY MACHINES

(71) Applicant: Howden Group Limited, Scotland (GB)

(72) Inventors: Brijeshkumar Patel, Glasgow (GB); Ryan Mochar, Cumbernauld (GB); William Murray Whyte, Glasgow (GB); Joanne Moore, Falkirk (GB); Dougal Hogg, Glasgow (GB)

(21) Appl. No.: 19/063,834

(22) Filed: Feb. 26, 2025

Related U.S. Application Data
(60) Provisional application No. 63/560,127, filed on Mar. 1, 2024.

(51) Int. Cl. F28D 19/04

(52) U.S. Cl. CPC F28D 19/047; F28F 2230/00

(57) ABSTRACT

A rotary machine includes a rotor with a plurality of plates defining openings therebetween, a housing enclosing the rotor, and a flow restrictor. The flow restrictor includes a body attached to a plate of the plurality of plates of the rotor and extending from the rotor toward the housing. The flow restrictor also includes a plurality of extensions extending from the body toward the housing to form a groove between extensions of the plurality of extensions.

### CROSS-REFERENCE TO RELATED APPLICATION

This application claims priority to and the benefit of U.S. Provisional Patent Application No. 63/560,127, filed Mar. 1, 2024, which is hereby incorporated by reference in its entirety for all purposes.

### FIELD OF INVENTION

The present invention relates to sealing and flow restrictor arrangements between zones of rotary heat exchangers, rotary adsorption machines and the like.

### BACKGROUND

Rotary adsorption machines (RAMs), which are also known as thermal swing adsorption machines, pressure swing adsorption machines, regenerative rotary separators, and the like, are often deployed to recover specific gasses, elements, and/or particulates, such as carbon dioxide. More specifically, RAMs are often deployed for point source carbon capture and/or for direct air carbon capture. In any case, RAMs typically include an adsorbent material, such as activated carbon, metal-organic frameworks (MOFs) or zeolite (e.g., hydrated aluminosilicates of alkaline and alkaline-earth metals), in a rotatable rotor.

Some RAMs include a cylindrical section that is configured to circumferentially surround the rotor and to define a plurality of zones through which the rotor can rotate. A plurality of ducts may define passageways into and out of the plurality of zones, and the cylindrical section may connect an inlet of each duct of the plurality of ducts to an outlet of each duct of the plurality of ducts. These zones can include an adsorption zone, a desorption zone, and a regeneration zone that typically operate at different temperatures and pressures. Two or more sector plate assemblies may define and/or separate adjacent zones. Meanwhile, in the rotor, radial plates extend between a central hub and an outer shell of the cylindrical section to at least partially define containers within which the adsorbent material is retained.

During operation of the RAM, a process gas, such as a carbon dioxide (CO₂)-laden gas, enters the rotor, and the target gasses, elements, and/or particulates (e.g., CO₂) is/are adsorbed onto the adsorbent material. The rotor then rotates the adsorbed substance into a desorption zone to release the target substance from the adsorbent so that the target substance can be captured, processed, or used. The desorption is caused by a change in pressure and/or a change in temperature (e.g., by passing steam through the rotor and/or through electric heating elements). Since these different zones are capturing and releasing a target substance and operate at different pressures, it is quite important to provide proper seals or flow restrictors between the zones to limit or eliminate fluid flow/leakage between them.

### SUMMARY

Disclosed are apparatuses for minimizing or eliminating leakage between adjacent zones of a rotary machine, such as a RAM. That is, while the present disclosure primarily describes seal applications for RAMs, the sealing arrangements disclosed herein are equally applicable to minimizing or eliminating leakage between adjacent zones of a rotary heat exchanger and like machines.

According to some implementations, a rotary machine is provided. The rotary machine includes a rotor with a plurality of plates defining openings therebetween, a housing enclosing the rotor, and a flow restrictor. The flow restrictor includes a body attached to a plate of the plurality of plates of the rotor and extending from the rotor toward the housing. The flow restrictor also includes a plurality of extensions extending from the body toward the housing to form a groove between extensions of the plurality of extensions.

According to some implementations, a flow restrictor of a rotary machine is provided. The flow restrictor includes a body configured to attach to a rotor of the rotary machine. The rotor includes a plurality of plates, and the body being configured to attach to a plate of the plurality of plates. The flow restrictor also includes a plurality of extensions extending from the body toward a housing of the rotary machine to inhibit fluid flow between the housing and the plate.

According to some implementations, a flow restrictor of a rotary machine is provided. The flow restrictor includes a body configured to attach to opposite sides of a plate of a rotor of the rotary machine and an extension extending from a distal end of the body, wherein the extension is configured to flex toward a housing of the rotary machine in response to a pressure differential across the rotor to provide a seal against the housing.

According to some implementations, a RAM is provided that comprises an adsorption zone, a desorption zone, and a regeneration zone. A sector plate having a first surface is disposed between adjacent or adjoining zones. The RAM includes a rotatable rotor having a plurality of spaced-apart radial plates that may at least partially define containers within which an adsorbent material may be retained. Each of the plurality of radial plates has a second surface that is configured to intermittently face towards the first surface of the sector plate as the rotor rotates. Each of the radial plates has a first side and a second side opposite the first side. It is appreciated that the sealing and flow restrictor apparatuses disclosed herein are applicable for use between other types of zones found in RAMs, and are also applicable for use in other equipment comprising adjacent zones that operate at different pressures.

According to some implementations, a sealing member is coupled to the radial plate and extends over at least a portion of the first surface of the sector plate. The sealing member includes a base that is attached to or coupled to the radial plate. A body of the sealing member that extends from the base towards the sector plate includes a first flexible flap located on the first side of the radial plate. The first flexible flap is transitional between a first state and a second state. When in the first state, the first flexible flap is spaced-apart from the first surface of the sector plate. The first flexible flap is configured such that when a pressure on the first side of the radial plate is greater than a pressure on the second side of the radial plate, the first flexible flap flexes to assume the second state wherein a portion of the first flexible flap contacts the first surface of the sector plate to minimize or prevent fluid leakage across the radial plate.

According to some implementations, the body of the sealing member further includes a second flexible flap located on the second side of the radial plate which is also transitional between a first state and a second state. When in the first state, the second flexible flap is spaced-apart from the first surface of the sector plate. The second flexible flap is configured such that when the pressure on the second side of the radial plate is greater than the pressure on the first side of the radial plate, the second flexible flap flexes to assume the second state wherein a portion of the second flexible flap contacts the first surface of the sector plate to minimize or prevent fluid leakage across the radial plate. In some of these instances, the first flexible flap and/or the second flexible flap changes shape when transitioning between the first and second states. Additionally or alternatively, when in the first state, the first flexible flap and/or second flexible flap has a convex surface and a concave surface opposite the convex surface with the convex surface facing the first surface of the sector plate. According to one such implementation, the first flexible flap and/or second flexible flap are/is wing-shaped at least when in the first state.

According to alternative implementations, fluid flow restriction across the radial plate is achieved through the use of a flow restrictor that is attached or coupled to the radial plate. The flow restrictor has a body that resides between the second surface of the radial plate and the first surface of the sector plate. The flow restrictor is configured to restrict or prevent fluid flow between the adjacent zones when the second surface of the radial plate is aligned with the first surface of the sector plate. An end portion of the flow restrictor that faces the first surface of the sector plate includes a plurality of walls that are spaced apart from one another to form a plurality of spaced-apart grooves that are arranged side-by-side in a width direction of the flow restrictor and a width direction of the sector plate. Each of the plurality of grooves has an opening that faces the first surface of the sector plate. Preferably, no portion of the flow restrictor contacts the sector plate such that a gap continuously exists between the distal end of the flow restrictor and the sector plate. This latter feature advantageously eliminates a wearing of the flow restrictor through contact with the sector plate.

According to some implementations, the plurality of walls includes first and second angled outermost walls with the first angled outermost wall extending outward in a direction of the first side of the radial plate and towards the first surface of the sector plate, and with the second angled outermost wall extending outward in a direction of the second side of the radial plate and towards the first surface of the sector plate. According to some implementations, the flow restrictor is configured such that when a pressure on the first side of the radial plate is greater than a pressure on the second side of the radial plate, a flow separation bubble is formed on a surface of the first angled outermost wall that faces the first surface of the sector plate. According to some implementations, the flow restrictor is also configured such that when a pressure on the second side of the radial plate is greater than a pressure on the first side of the radial plate, a flow separation bubble is formed on a surface of the second angled outermost wall that faces the first surface of the sector plate. The flow separation bubbles advantageously minimize or impede fluid flow across the width of the flow restrictor.

According to some implementations, the flow restrictor is configured such that fluid flow expansion losses occur at the entrances of one or more of the plurality of grooves, and fluid flow contraction losses occur between one or more sets of grooves when a pressure on the first side of the radial plate is greater than a pressure on the second side of the radial plate, or when a pressure on the second side of the radial plate is greater than the pressure on the first side of the radial plate. The direction of fluid flow is always from the high-pressure side to the low-pressure side. Therefore, when the pressure difference alternates, the position of the entrances at the grooves alternates correspondingly.

According to some implementations, the flow restrictor is configured such that fluid flow vortices form inside one or more of the plurality of grooves when a pressure on the first side of the radial plate is greater than a pressure on the second side of the radial plate, or when a pressure on the second side of the radial plate is greater than the pressure on the first side of the radial plate. The formation of flow vortices inside one or more of the grooves advantageously minimizes or impedes fluid flow across the width of the flow restrictor.

According to other implementations, the minimizing or prevention of fluid flow between the adjacent zones is achieved through the use of a sealing member that includes a metallic spring assembly having first and second undulating side sections that are arranged symmetrical to one another. End portions of the undulating side sections are attached or coupled to the radial plate. A second end portion of the metallic spring assembly is configured to press against the first surface of the sector plate when the second surface of the radial plate is aligned with the first surface of the sector plate to minimize or prevent fluid flow between the adjacent zones. According to some implementations, the second end portion includes leading and trailing ramp surfaces that facilitate a smooth compression and decompression of the spring assembly as the sealing member respectively approaches and moves away from the sector plate. When the second surface of the radial plate is aligned with the first surface of the sector plate, at least a portion of the leading ramp surface is located on the first side of the radial plate and at least a portion of the trailing ramp surface is located on the second side of the radial plate. Importantly, the symmetric arrangement of the sealing member continuously urges the second portion of the sealing member towards a vertical alignment with the radial plate. This advantageously urges the second portion of the sealing member towards a flush relationship with the first surface of the sector plate.

According to other implementations, the minimizing or prevention of fluid flow between the adjacent zones is achieved through the use of a sealing member that includes a metallic spring assembly and a non-spring element. The metallic spring assembly includes first and second undulating side sections that are arranged symmetrical to one another. End portions of the undulating side sections are attached or coupled to the radial plate. A proximal end portion of the non-spring element is coupled to and supported by the metallic spring assembly. A distal end portion of the non-spring element has a surface that is configured to press against the first surface of the sector plate when the second surface of the radial plate is aligned with the first surface of the sector plate. The non-spring element includes leading and trailing ramp surfaces that facilitate a smooth compression and decompression of the metallic spring assembly as the sealing member respectively approaches and moves away from the sector plate. When the second surface of the radial plate is aligned with the first surface of the sector plate at least a portion of the leading ramp surface is located on the first side of the radial plate and at least a portion of the trailing ramp surface is located on the second side of the radial surface. The symmetric arrangement of the metallic spring assembly advantageously urges the non-spring element towards a vertical alignment with the radial plate.

According to some implementations, the non-spring element is a made of a rigid material that does not deform when the surface of the distal end portion of the non-spring element is pressed against the first surface of the sector plate. An advantage of using the non-spring element is that it may be made of a material that is more wear resistant then the spring assembly and can be coupled to the spring assembly in a way that makes it more readily replaceable as will be discussed in more detail below.

These and other advantages and features will become evident in view of the drawings and detailed description.

### BRIEF DESCRIPTION OF THE DRAWINGS

To complete the description and in order to provide for a better understanding of the present invention, a set of drawings is provided. The drawings form an integral part of the description and illustrate implementations of the present invention, which should not be interpreted as restricting the scope of the invention, but just as an example of how the invention can be carried out. The drawings comprise the following figures:

FIG. 1 is a schematic view of a combined cycle power plant with a rotary adsorption machine (RAM) formed in accordance with an example implementation.

FIG. 2 is a top, front perspective view of a RAM formed in accordance with an example implementation.

FIG. 3 is a partially cut-away perspective view of a portion of the RAM of FIG. 2.

FIG. 4A is a cross-sectional view of an embodiment of a sealing assembly that includes an elastomeric member attached to or otherwise coupled to a radial plate of the RAM of FIG. 2, and flaps of the elastomeric member are in a first state in which each flap is spaced apart from the sector plate.

FIG. 4B shows the sealing assembly of FIG. 4A with there being a pressure differential between sides of the radial plate to result in the flap on a high pressure side being flexed to press against a surface of a housing.

FIG. 5A is a cross-sectional view of an embodiment of a flow restrictor located between a radial plate and a housing in which one or more of fluid separation, fluid expansion loss, or fluid contraction loss is induced to minimize or prevent fluid flow leakage between adjacent zones of a RAM.

FIG. 5B illustrates the flow restrictor of FIG. 5A, showing areas of fluid separation, fluid flow expansions, fluid flow contractions, and fluid vortices induced by the configuration of the flow restrictor.

FIG. 6 is a cross-sectional view of another embodiment of a flow restrictor that is configured to induce one or more of fluid separation, fluid expansion loss, or fluid contraction loss to minimize leakage between adjacent zones of a RAM.

FIG. 7 is a cross-sectional view of yet another embodiment of a flow restrictor that is configured to induce one or more of fluid separation, fluid expansion loss, or fluid contraction loss to minimize leakage between adjacent zones of a RAM.

FIG. 8 is a cross-sectional view of still another embodiment of a flow restrictor that is configured to induce one or more of fluid separation, fluid expansion loss, or fluid contraction loss to minimize leakage between adjacent zones of a RAM.

FIG. 9 is a cross-sectional view of an embodiment of a symmetrical spring structure arranged between a radial plate and a housing of a RAM. The spring structure includes leading and trailing ramp sections and grooves located between the ramp sections.

FIG. 10 is a cross-sectional view of another embodiment of a sealing member similar to that of FIG. 9, in which the leading ramp, trailing ramp, and grooves are not comprised in the spring structure, but in a non-spring element coupled to the spring structure.

FIG. 11 illustrates a portion of the RAM of FIG. 2 in greater detail to provide another location for placement of a sealing member.

FIG. 12 illustrates another portion of the RAM of FIG. 2 in greater detail to provide yet another location for placement of a sealing member.

### DETAILED DESCRIPTION

Generally, this application is directed to a rotary adsorption machine (RAM). However, it is important to note that the sealing and flow restrictor arrangements disclosed herein are also applicable for use in rotary heat exchangers, including low temperature rotary heat exchangers (e.g., those operating at less than 200° C.) and cold temperature rotary heat exchangers. Disclosed herein are sealing arrangements to reduce or eliminate the leakage of fluids (gases and/or liquids) between the zones of a RAM, a rotary heat exchanger, and the like for the purpose of increasing their effectiveness.

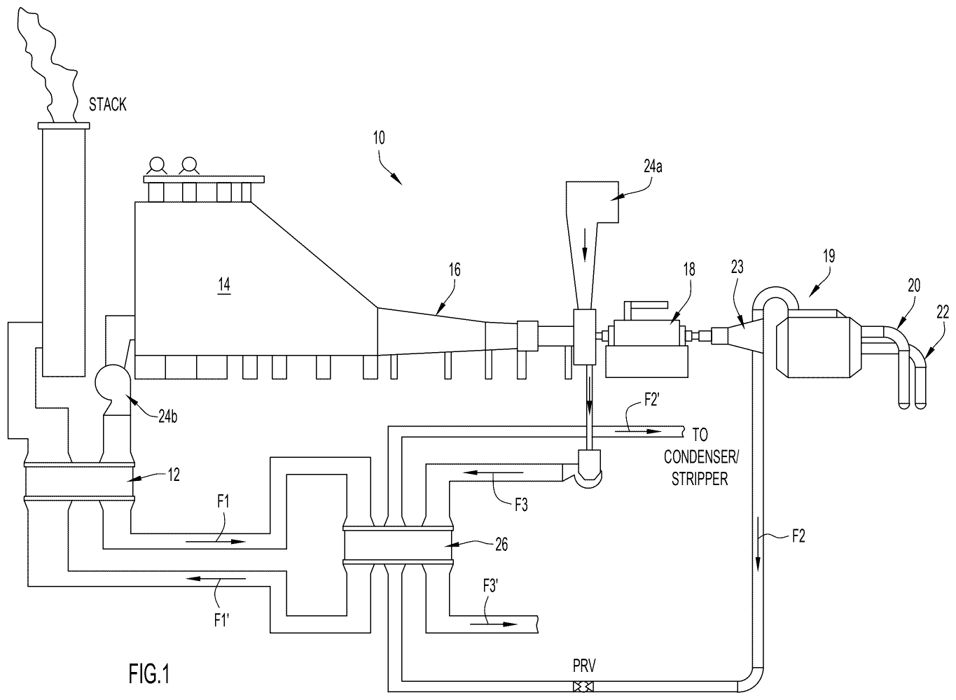

An example power plant 10 of a type that may incorporate a RAM 26 formed in accordance with the present application is illustrated in FIG. 1. However, to be clear, the power plant 10 of FIG. 1 is merely an example and, in other implementations, RAM 26 may be positioned in any desirable location, e.g., for carbon capture. For example, power plant 10 generally depicts a combined cycle gas turbine (CCGT) power plant, but the RAM 26 could also be positioned/included in a conventional coal powered power plant or any other flue system (e.g., for point source capture). In fact, it is envisioned that the RAM 26 presented herein may be configured to capture carbon dioxide from ambient air. That is, the RAM 26 presented herein may be positioned in locations in which CO₂-laden gas entering the RAM 26 is ambient air (as opposed to a process effluent).

That said, in FIG. 1, the power plant 10 includes a gas turbine 16, a Heat Recovery Steam Generator (HRSG) 14, and a generator 18 coupled with a steam turbine 23. Turbines 16 and 23 combine to drive the generator 18 to produce electricity. The steam turbine 23 is connected to a condenser 19 with an intake 20 and exhaust 22. The power plant 10 also includes fans 24a and 24b, which may be used to move air through this system. Meanwhile, a heat exchanger 12 may be positioned adjacent the exhaust of the HRSG 14. Although not shown, a power plant utilizing the RAM 26 might also include another heat exchanger to heat the air entering a boiler. For example, such a heat exchanger might heat air entering a boiler with heat from combustion gases expelled from the boiler (while also cooling the gas expelled from the boiler).

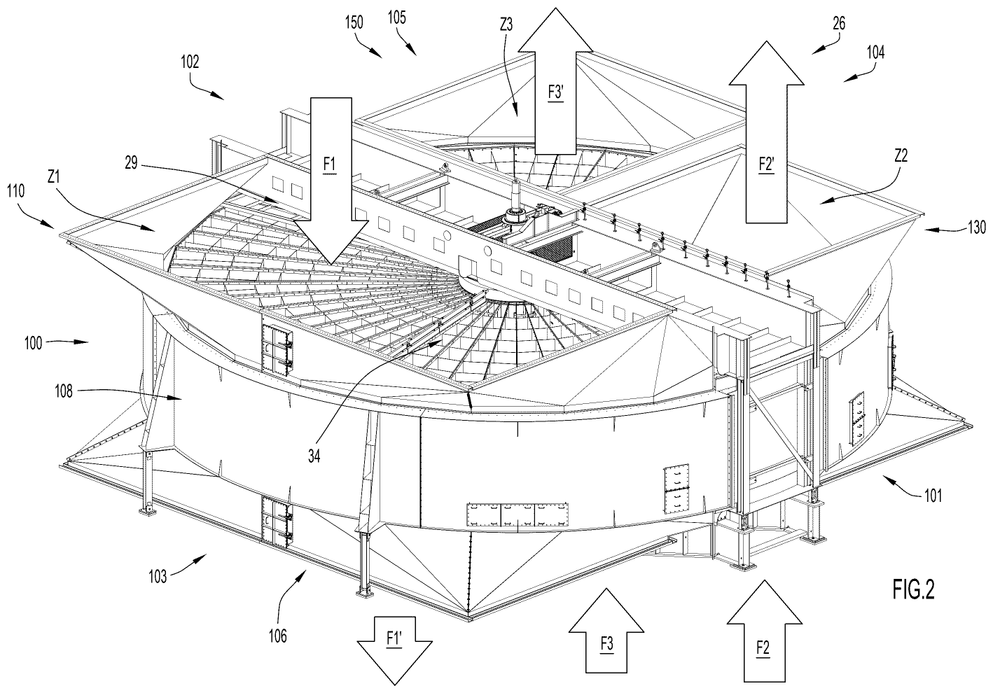

As shown in FIG. 1 and in combination with FIG. 2, which illustrates the RAM 26 of FIG. 1 in further detail, the cooled exhaust gas enters the RAM 26 as a first flow F1 and enters the RAM 26 via a first duct 110. However, to reiterate, exhaust gas is merely one example of gas that may enter the RAM 26 as first flow F1. As other examples, the first flow F1 may be a flow of ambient air and/atmosphere, or a combination of ambient air/atmosphere and an exhaust gas. In any case, when the first flow F1 encounters a rotor 34 included in the RAM 26, adsorptive elements in the rotor 34 can adsorb a specific portion of the first flow F1 (e.g., carbon dioxide). Then, the adsorptive elements in the rotor 34 can carry the adsorbed portion of the first flow F1 through a partial rotation. Meanwhile, a portion of the first flow F1 that is not captured by the adsorptive elements may exit the RAM 26 as process flow F1′, e.g., to (or back to) atmosphere, e.g., by way of heat exchanger 12 where it can be used to cool exhaust gas. Additionally or alternatively, the process flow F1′ could be fed to a conduit that directs the process flow F1′ to a downstream processing operation that requires clean gas/air. The area of the rotor 34 aligned with the first flow F1 may generally be referred to herein as a first zone Z1 (i.e., an adsorptive zone Z1) of the RAM 26.

As the rotor 34 rotates, it moves the adsorbed portion of the first flow F1 (e.g., carbon dioxide) out of the adsorptive zone Z1 (e.g., by rotating the adsorptive elements that have adsorbed the portion of the first flow F1) and into a second zone Z2 (i.e., a desorption zone Z2) of the RAM 26. In the desorption zone Z2, a second flow F2 is directed into the RAM 26 to cause the adsorptive elements of rotor 34 carrying the adsorbed portion of the first flow F1 to desorb the adsorbed portion of the first flow F1. For example, steam may be directed into the RAM 26 as the second flow F2 to create a temperature change that releases carbon dioxide from adsorptive elements for carbon capture. To illustrate this example, the steam of the second flow F2 emanates from steam turbine operations (e.g., from condenser 19) in FIG. 1. In any case, the adsorbed portion of the first flow F1 is released into the second flow F2 to generate a flow F2′ exiting RAM 26. By way of example, the flow F2′ may carry carbon dioxide and may be directed to a storage tank, condenser, and/or stripper, e.g., to prevent the carbon dioxide from entering or re-entering the atmosphere (e.g., to remove carbon dioxide from the atmosphere).

After adsorptive elements desorb the adsorbed portion of the first flow F1 (e.g., carbon dioxide), the adsorptive elements may move into a third zone Z3 (i.e., a regeneration zone Z3). In the third zone Z3, conditioning air (e.g., driven by fan 24a) may flow through the RAM 26 to “regenerate” the adsorptive elements, entering as flow F3 and exiting as flow F3′(which, may, in some instances, combine with the process flow F1′ on exiting the RAM 26, as shown in FIG. 1). This conditioning air prepares the adsorptive elements to re-enter the adsorption zone Z1 (e.g., by cooling the adsorptive elements) so that the adsorptive elements can continue cycling through the three zones of the RAM 26. That is, continued rotation of a particular adsorptive element of rotor 34 through a full 360° rotation within the RAM 26 will cause the particular adsorptive element to adsorb a specific portion of the first flow F1, desorb the flow component, and regenerate. Thus, a cylindrical rotor 34 full of adsorptive elements will continuously capture a component/portion of a first flow of gas F1 entering the RAM 26.

However, to be clear, the RAM 26 illustrated in the figures of this application is merely an example and other implementations may include any number of variations. For example, a RAM 26 formed in accordance with the present application may include any number of zones, e.g., to incorporate isolation zones, multiple stages or regeneration, desorption, and/or adsorption, or for any other reason. Additionally or alternatively, the various flows entering and exiting the RAM 26 may emanate from any desirable source or flow to any desirable location, including a source of that flow or another flow (e.g., to recycle flows of fluid). As yet another example, the composition of the various flows can be varied, such as by using a fluid flow other than steam for desorption.

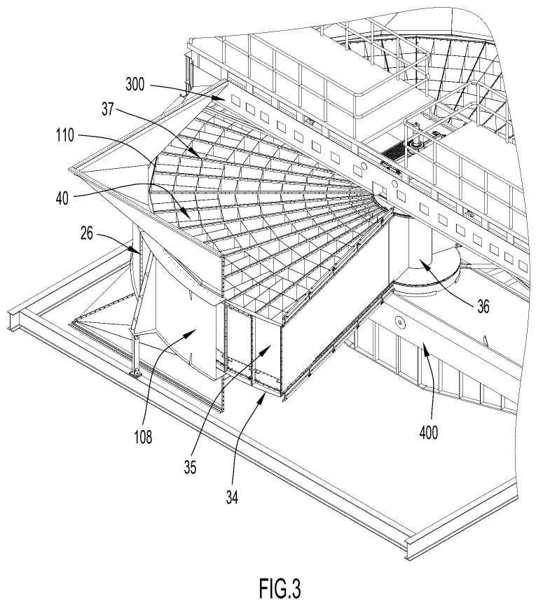

FIG. 3 illustrates the RAM 26 of FIG. 2 in greater detail by providing a cut-away view of a portion of the RAM 26. FIGS. 2 and 3 are discussed together to describe the RAM 26. At a high-level, the RAM 26 includes a rotor 34 that is rotatable within a housing 100. The housing 100 is specifically designed to enclose and seal against portions of the rotor 34 to help dictate how and where fluid (e.g., gas) will enter, exit, or move with the rotor 34. As mentioned, the RAM 26 presented herein, including the housing 100 and rotor 34, may be particularly suitable for large scale (e.g., industrial) operations. Thus, in at least some instances, the rotor 34 may have a diameter equal to or greater than 20 meters, such as 24 meters, and the housing 100 may be sized accordingly.

As can be seen in FIG. 3, the rotor 34 includes a central hub 36 and an outer shell 35. Radial plates 37 extend between the central hub 36 and the outer shell 35 and are offset from one another to at least partially define containers or openings 40 therebetween. The containers 40 are configured to receive and retain adsorbent material. In at least some implementations, the rotor 34 also includes circumferential plates to subdivide the containers 40. Either way, adsorbent material may be stored and/or installed within the containers 40. For example, adsorbent material may be “dropped down” into the containers 40 to fill the rotor 34 with adsorbent material. In at least some instances, the adsorbent may be formed from any adsorbent now known or developed hereafter that is suitable for adsorbing carbon dioxide, such as activated carbon, MOFs, zeolite(s), or combinations thereof.

As mentioned, the rotor 34 is configured to continuously rotate around the central hub 36 to move radially aligned containers 40 through a cycle of zones (e.g., through zones Z1, Z2, and Z3). During this rotation, the housing 100 is generally designed to circumferentially retain gas in the rotor 34 and to create pathways along which fluid can axially enter or exit the rotor 34. The circumferential retention can be achieved by closely positioning a cylindrical section 108 of the housing 100 against the outer shell 35 of the rotor 34. Additionally, sector plates located between the zones of the RAM are equipped with features that facilitate producing a seal between the zones for the purpose of minimizing or eliminating fluid flow between the zones. FIG. 2 shows an example sector plate 29 positioned between the adsorption zone (Z1) and the regeneration zone (Z3) and above the radial plates 37. In the depicted implementation, a first sector plate 29 separates the adsorption zone Z1 (generally aligned with first duct 110) from at least the regeneration zone Z3.

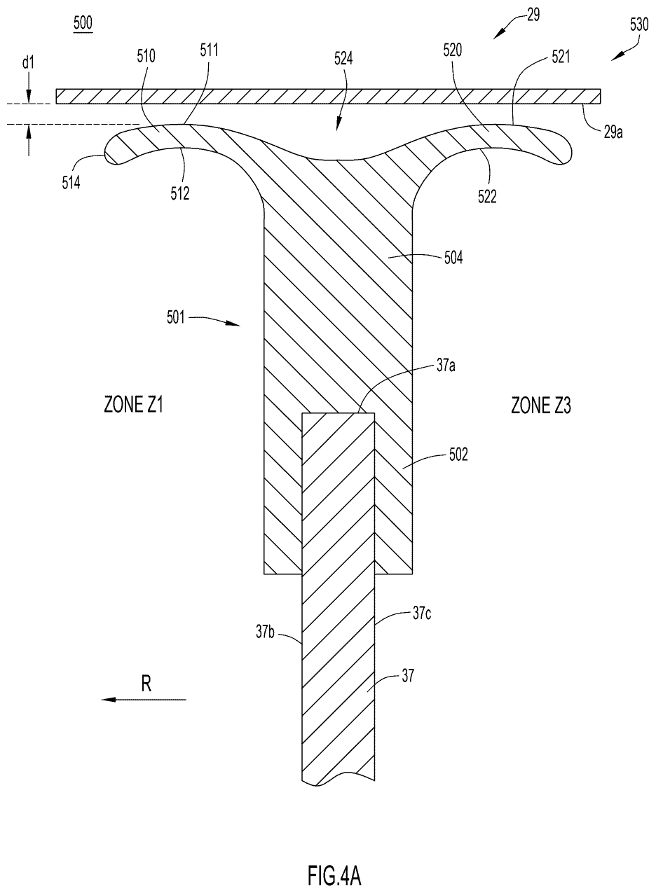

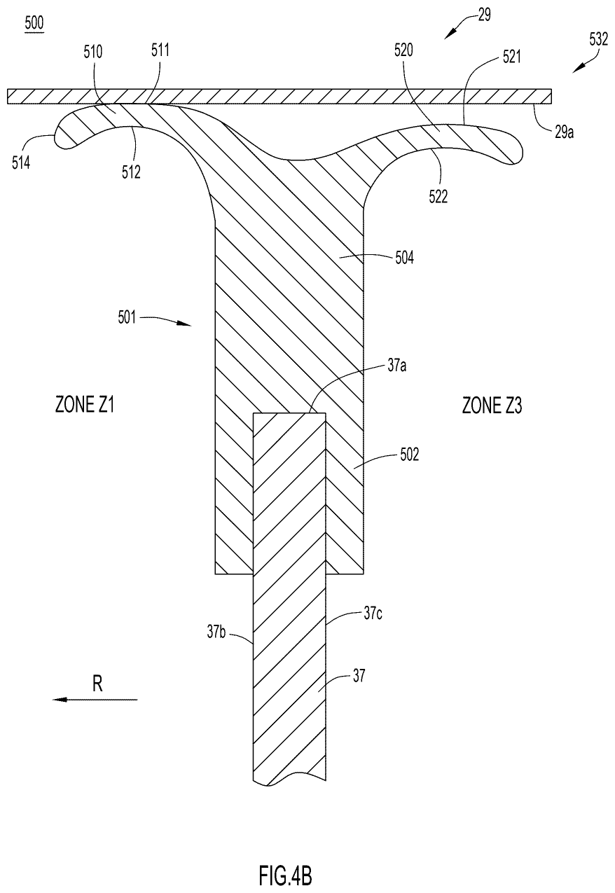

The examples disclosed below are directed to sealing arrangements between the first sector plate 29 and radial plates 37. Moreover, the examples are directed to sealing arrangements between an end surface 37a (e.g., an outer surface, a top surface, see, e.g., FIG. 4A) of the radial plates 37 with a first surface 29a (e.g., an inner surface, a bottom surface, a lower surface, see, e.g., FIG. 4A) of the first sector plate 29. A second sector plate (not shown in the figures), similar to and horizontally aligned with the first sector plate 29 is typically disposed below the radial plates 37. The sealing arrangements disclosed herein are equally applicable to producing a seal between a bottom end of the radial plates 37 with a top surface of the second sector plate. Similarly, the sealing arrangements disclosed herein may be equally applicable to longitudinally extending surfaces extending between the bottom and top sector plates (e.g., vertically extending portions of a sector assembly). With reference to FIGS. 2 and 3, the aforementioned first and second sector plates may be respectively attached or coupled to top and bottom frame assemblies 300 and 400 of RAM 26. Although not shown in FIG. 2, similar sets of sector plates may be disposed between the adsorption zone (Z1) and desorption zone (Z2) and also between the desorption zone (Z2) and the regeneration zone (Z3).

With continued reference to FIGS. 2 and 3, overall, the housing 100 extends from a front 101 to a back 102, from a first side 103 to a second side 104, and from a bottom 106 to a top 105. In the depicted implementation, different streams of fluid enter or exit the RAM 26 in a generally vertical or longitudinal manner (i.e., from the bottom 106 to the top 105, or vice versa). Thus, the housing 100: (a) includes a cylindrical section 108 that circumferentially surrounds the rotor 34; and (b) defines a plurality of ducts at the top 105 and bottom 106 of the RAM 26. Specifically, in the depicted implementation, the RAM 26 includes three ducts that are generally aligned with zones Z1, Z2, and Z3: (1) a first duct 110 generally aligned with adsorption zone Z1; (2) a second duct 130 generally aligned with desorption zone Z2; and (3) a third duct 150 generally aligned with regeneration zone Z3. However, other implementations may include any number of ducts and do not necessarily need to include the same number of ducts and zones.

In the depicted implementation, the first duct 110 extends from an inlet disposed adjacent the top 105 of the housing 100 to an outlet disposed adjacent the bottom 106 of the housing 100. Meanwhile, the second duct 130 and third duct 150 extend from inlets that are positioned adjacent the bottom 106 of the housing 100 to outlets that are respectively positioned adjacent the top 105 of the housing 100. Thus, the first flow F1 entering the first duct 110 generally flows in a first longitudinal direction (e.g., downwards) while flows F2 and F3 entering ducts 130 and 150 generally flow in an opposite longitudinal direction (e.g., upwards). As specific examples, the first flow F1 may comprise ambient air and/or a process effluent flowing downwards into the rotor 34 via the inlet of the first duct 110 while the second flow F2 comprises steam flowing upwards into the rotor 34 via the inlet of second duct 130 and the third flow F3 comprises conditioning air flowing upwards into rotor 34 via the inlet of third duct 150.

In the examples that follow, reference is made to sealing members and flow restrictors located between the end surfaces 37a of the radial plates 37 and the first surface 29a of the sector plate 29 situated between the adsorption zone (Z1) and the regeneration zone (Z3). It is appreciated that such sealing arrangements are equally applicable to radial plate/housing interfaces in other locations of the RAM 26, including locations that prevent or inhibit leakage between adjacent zones and/or circumferential leakage around a rotor and/or matrix. That is, the sealing members and flow restrictors may be coupled or attached to any of the upper and lower ends of the radial plates 37 to seal against one or more other plates located in the RAM 26 but may also be coupled or attached to circumferential sections, axial plates, axial ends of radial plates, etc.

FIGS. 4A and 4B are each a cross-sectional view of a sealing arrangement 500 according to one implementation in which the sector plate 29 is aligned with one of the plurality of radial plates 37 via rotation of a rotor of a RAM (e.g., the RAM 26). That is, an end surface 37a (also referred to herein as “second surface”) of the radial plate 37 is situated facing the first surface 29a of the sector plate 29. The radial plate 37 has first and second opposite sides 37b and 37c that respectively reside in zones Z1 and Z3 of the RAM. For discussion purposes, zone Z1 will be assumed to operate at a higher pressure than zone Z3. As previously discussed, the radial plate 37 is one of a plurality of spaced-apart radial plates that rotates inside a housing of the RAM. Arrow “R” indicates the direction of rotation.

The sealing arrangement 500 includes a sealing member 501 attached to the radial plate 37. The sealing member 501 includes a base 502 that is attached to or otherwise coupled to the radial plate 37 by any suitable attachment means which may include the use of bolts, screws, an adhesive, an interference fit, etc. By way of example, the base 502 may capture the sides 37b and 37c of the radial plate 37.

The body 504 of the sealing member 501 extends from the base 502 towards the sector plate 29 and includes a first flexible flap or extension 510 (e.g., a leading flexible flap) located primarily on the first side 37b of the radial plate 37. The first flexible flap 510 is transitional between a first state 530 as shown in FIG. 4A and a second state 532 as shown in FIG. 4B. When in the first state 530, the first flexible flap 510 is spaced-apart from the first surface 29a of the sector plate 29 by a distance d1, which may be in the range of 0 millimeters and 4 millimeters. The first flexible flap 510 is configured such that a pressure differential in which the pressure on the first side 37b of the radial plate 37 is greater than the pressure on the second side 37c of the radial plate causes the first flexible flap 510 to flex and assume the second state 532 wherein a portion of the first flexible flap 510 contacts the first surface 29a of the sector plate 29 to minimize or prevent fluid leakage between zones Z1 and Z3.

According to some implementations, the body 504 of the sealing member 501 further includes a second flexible flap or extension 520 (e.g., a trailing flexible flap) located primarily on the second side 37c of the radial plate 37. When in the first state, the second flexible flap 520 is spaced-apart from the first surface 29a of the sector plate 29. The second flexible flap 520 is configured such that a pressure differential in which the pressure on the second side 37c of the radial plate 37 is greater than the pressure on the first side 37b of the radial plate 37 causes the second flexible flap 520 to flex and assume another second state 532 wherein a portion of the second flexible flap contacts the first surface 29a of the sector plate 29 to minimize or prevent fluid leakage between zones Z1 and Z3.

As illustrated in FIGS. 4A and 4B, the first flexible flap 510 has a first shape when in the first state 530 and a second shape different than the first shape when in the second state 532. In implementations wherein the sealing member 501 includes the second flexible flap 520, the second flexible flap 520 may additionally or alternatively change shape when transitioning between its first and second states 530, 532.

As shown in FIG. 4A, according to some implementations, the first and second flexible flaps 510, 520 have a same or similar shape when in their first states 530. Although not shown in the figures, according to some implementations, the first and second flexible flaps 510, 520 have a same or similar shape when in their second states.

According to some implementations, the first and second flexible flaps 510, 520 are wing-shaped when in their first state 530 as shown in FIG. 4A and may or may not be wing-shaped when in their second state 532. According to some implementations, the first flexible flap 510 has a convex surface 511 and a concave surface 512 opposite the convex surface 511, with the convex surface 511 facing the first surface 29a of the sector plate 29. In implementations wherein the sealing member 501 includes the second flexible flap 520, the second flexible flap 520 has a convex surface 521 and a concave surface 522 opposite the convex surface 521 with the convex surface 521 facing the first surface 29a of the sector plate 29. The convex surface 511, 521 of each of the first and second flexible flaps 510, 520 is preferably curved to facilitate a smooth engagement and disengagement of the flexible flaps 510, 520 with the sector plate 29. For the same reason, according to some implementations, at least the first flexible flap 510 includes a leading curved surface 514. Additionally, the curved profile of the flexible flaps 510, 520 forms a groove 524 therebetween. In some embodiments, the groove 524 can further help restrict fluid leakage between zones Z1 and Z3. By way of example, the groove 524 may provide a discontinuity that disrupts fluid flow between the sector plate 29 and the sealing member 501 along the flexible flaps 510, 520.

To minimize wear of the sector plate 29 and the sealing member 501, at least portions of the first and second flexible flaps 510, 520 that are intended to contact the sector plate may possess a lubricious coating. This coating may facilitate movement of the flexible flaps 510, 520 along the sector plate 29 and reduce potential abrasion of the sector plate 29 against the flexible flaps 510, 520. The lubricious coating may comprise, for example, polytetrafluoroethylene (PTFE).

According to some implementations, each of the first and second flexible flaps 510, 520 is made of an elastomeric material that enables it to automatically transition from its second state 532 towards its first state 530. That is, the elastomeric material is able to bend or deform when a load (e.g., a pressure) is applied to it, and the elastomeric material is able to fully recover or substantially recover its original shape when the load is removed. According to other implementations, the first and second flexible flaps 510, 520 are respectively made of first and second flexible strips of spring metal to be able to bend in response to a load and recover its original shape absent the load. According to some implementations, the sealing member 501 is a unitary structure (i.e., is made from a single piece of material).

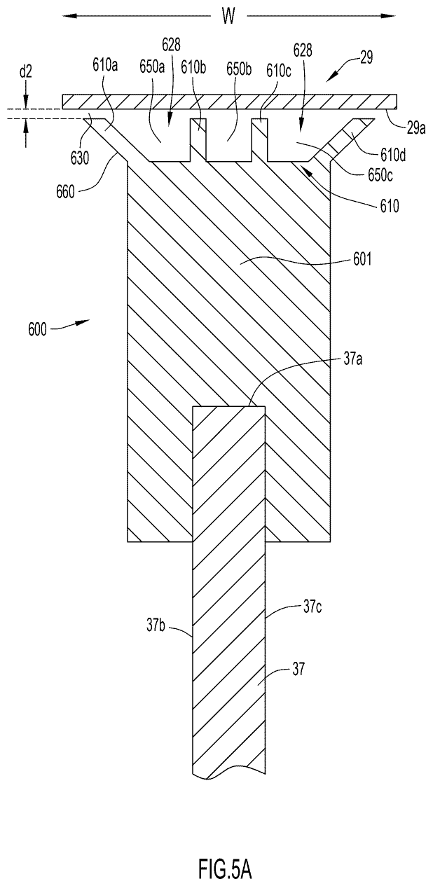

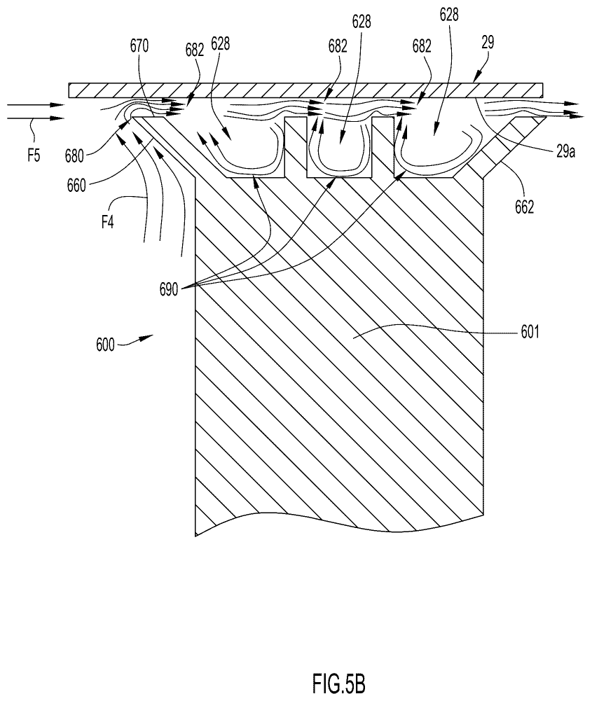

FIG. 5A illustrates a cross-sectional view of a flow restrictor 600 located between the radial plate 37 and the sector plate 29 in which one or more of fluid separation, fluid expansion loss, or fluid contraction loss is induced to minimize or prevent fluid flow leakage between adjacent zones of a RAM. FIG. 5B illustrates the flow restrictor of FIG. 5A, showing areas of fluid separation, fluid flow expansion, fluid flow contraction, and fluid vortices induced by the configuration of the flow restrictor.

According to some implementations, fluid flow restriction across the radial plate 37 is achieved through the use of the flow restrictor 600 that is attached or coupled to the radial plate 37. The flow restrictor 600 has a body 601 that resides between the second surface 37a of the radial plate 37 and the first surface 29a of the sector plate 29. For example, the body 601 may be attached to the radial plate 37 by capturing the sides 37b and 37c of the radial plate 37 and/or via the use of bolts, screws, an adhesive, an interference fit, etc. The flow restrictor 600 is configured to restrict or prevent fluid flow between the adjacent zones (e.g., zones Z1 and Z3) when the second surface 37a of the radial plate 37 is aligned with the first surface 29a of the sector plate 29. An end portion 610 of the flow restrictor 600 that faces the first surface 29a of the sector plate 29 includes a plurality of walls or extensions 610a-d that are spaced apart from one another to form a plurality of spaced-apart grooves 650a-c that are arranged side-by-side in a width direction “w” of the flow restrictor 600 and a width direction “w” of the sector plate 29. Each of the plurality of grooves 650a-c has an opening 628 that faces the first surface 29a of the sector plate 29. Preferably, no portion of the flow restrictor 600 contacts the sector plate 29 such that a gap 630 continuously exists between the distal-most end of the flow restrictor 600 (an end of the flow restrictor 600, such as of one of the walls 610a-d, nearest the sector plate 29) and the first surface 29a of the sector plate 29. This latter feature advantageously eliminates a wearing of the flow restrictor 600 and the sector plate 29 that would otherwise occur through contact therebetween. According to some implementations, a distance d2 between the distal-most end of the flow restrictor 600 and the first surface 29a of the sector plate 29 is in the range of 1 to 2 millimeters.

According to some implementations, the plurality of walls 610a-610d includes first and second angled outermost walls 610a and 610d, with the first angled outermost wall 610a extending outward in an oblique direction of the first side 37b of the radial plate 37 towards the first surface 29a of the sector plate 29, and with the second angled outermost wall 610d extending outward in an oblique direction of the second side 37c of the radial plate 37 towards the first surface 29a of the sector plate 29. According to some implementations, the flow restrictor 600 is configured such that, when a pressure on the first side 37b of the radial plate 37 is greater than a pressure on the second side 37c of the radial plate 37 to urge fluid flow from the first side 37b toward the second side 37c, a flow F4 is directed by the angled surface 660 of the first angled outermost wall 610a towards the first surface 29a of the sector plate 29 and in a direction opposite flow F5 which is directed towards gap 630. In this manner, flow F4 deflects or impinges against the flow F5 to alter the trajectory of the flow F5, thereby impeding the entry of flow F5 into gap 630. In addition, a flow separation bubble 680 may be formed on a distal surface 670 of the first angled outermost wall 610a that faces the first surface 29a of the sector plate 29. According to some implementations, the same flow phenonium occurs on the opposite side of the radial plate 37 when a pressure on the second side 37c of the radial plate 37 is greater than a pressure on the first side 37b of the radial plate 37 to urge fluid flow from the second side 37c toward the first side 37b. In addition, a flow separation bubble may formed on a distal surface 662 of the second angled outermost wall 610d that faces the first surface 29a of the sector plate 29. The formation of a flow separation bubble advantageously minimizes or impedes fluid flow across the angled outermost walls 610a or 610d, as the case may be. In the example of FIGS. 5A and 5B, walls 610b and 610c are arranged orthogonal to the first surface 29a of the sector plate 29. According to other implementations, walls 610b and 610c may be arranged non-orthogonal to the first surface 29a.

According to some implementations, the flow restrictor 600 is configured such that fluid flow expansion losses or fluid flow contraction losses 682 occur at the opening 628 of one or more of the plurality of grooves 650a-c when there is a pressure differential between the first side 37b of the radial plate 37 and the second side 37c of the radial plate 37. Moreover, according to some implementations, the flow restrictor 600 is configured such that fluid flow vortices 690 form inside one or more of the plurality of grooves 650a-c when there is a pressure differential between the first side 37b of the radial plate 37 and the second side 37c of the radial plate 37. The formation of fluid flow vortices 690 inside one or more of the grooves advantageously minimizes or impedes fluid flow across the width of the flow restrictor 600, such as by deflecting or otherwise reducing fluid flow advancing along the first surface 29a of the sector plate 29.

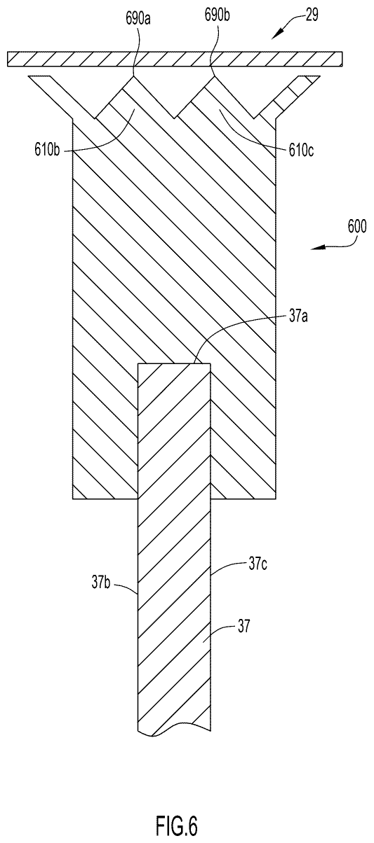

FIG. 6 illustrates a cross-sectional view of the flow restrictor 600 having walls 610b and 610c that are triangular and have a respective apex 690a and 690b that each points towards the first surface 29a of the sector plate 29 when the second surface 37a of the radial plate 37 is aligned with the first surface 29a of the sector plate 29. Such a shape of the walls 610b and 610c can create flow, such as flow vortices, that impedes fluid flow across the width of the flow restrictor 600.

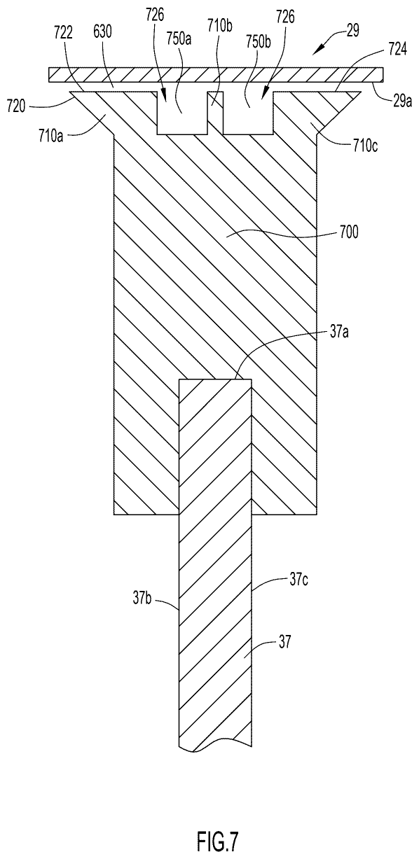

FIG. 7 illustrates a cross-sectional view of another flow restrictor 700 that is configured to induce one or more of fluid separation, fluid expansion loss, or fluid contraction loss to minimize fluid leakage between adjacent zones of a RAM. Flow restrictor 700 functions similar to flow restrictor 600 and includes a plurality of walls 710a-c that includes first and second angled outermost walls 710a and 710c and a central wall 710b disposed between them. A first groove 750a is formed between the first angled outermost wall 710a and the central wall 710b, and a second groove 750b is formed between the second angled outermost wall 710c and the central wall 710b.

The first angled outermost wall 710a extends outward in an oblique direction of the first side 37b of the radial plate 37 towards the first surface 29a of the sector plate 29, and the second angled outermost wall 710c extends outward in an oblique direction of the second side 37c of the radial plate 37 towards the first surface 29a of the sector plate 29. According to some implementations, the central wall 710b is arranged orthogonal to the first surface 29a of the sector plate 29.

According to some implementations, the flow restrictor 700 is configured such that when a pressure on the first side 37b of the radial plate 37 is greater than a pressure on the second side 37c of the radial plate 37, similar to what is illustrated in FIG. 5B, a first flow is directed along a surface 720 of the first angled outermost wall 710a towards the first surface 29a of sector plate 29 and in a direction opposite to a second flow that flows in a direction towards gap 630. The first flow causes a redirection of the second flow to restrict it from entering the gap 630. In addition, a flow separation bubble (not shown) may be formed on a distal surface 722 of the first angled outermost wall 710a that faces the first surface 29a of the sector plate 29. According to some implementations, the same flow phenonium occurs on the opposite side of the radial plate 37 when a pressure on the second side 37c of the radial plate 37 is greater than a pressure on the first side 37b of the radial plate 37. According to some implementations, the flow restrictor 700 is also configured such that when a pressure on the second side 37c of the radial plate 37 is greater than a pressure on the first side 37b of the radial plate 37, a flow separation bubble (not shown) is formed on a distal surface 724 of the second angled outermost wall 710c that faces the first surface 29 of the sector plate 29. As explained above, the formation of flow separation bubbles advantageously minimizes or impedes fluid flow across the angled outermost walls 710a or 710c.

According to some implementations, the flow restrictor 700 is configured such that fluid flow expansion losses (not shown) occur at an opening 726 of one or more of the first and second grooves 750a and 750b and a fluid flow contraction loss (not shown) occurs between the first and second grooves 750a and 750b when there is a pressure differential between the first side 37b of the radial plate 37 and the second side 37c of the radial plate 37. According to some implementations, the flow restrictor 700 is configured such that fluid flow vortices (not shown) form inside one or both of the first and second grooves 750a and 750b when there is a pressure differential between the first side 37b of the radial plate 37 and the second side 37c of the radial plate 37. The formation of flow vortices inside one or both of the grooves 750a and 750b advantageously minimizes or impedes fluid flow across the width of the flow restrictor 700, such as by deflecting or otherwise reducing fluid flow advancing along the first surface 29a of the sector plate 29.

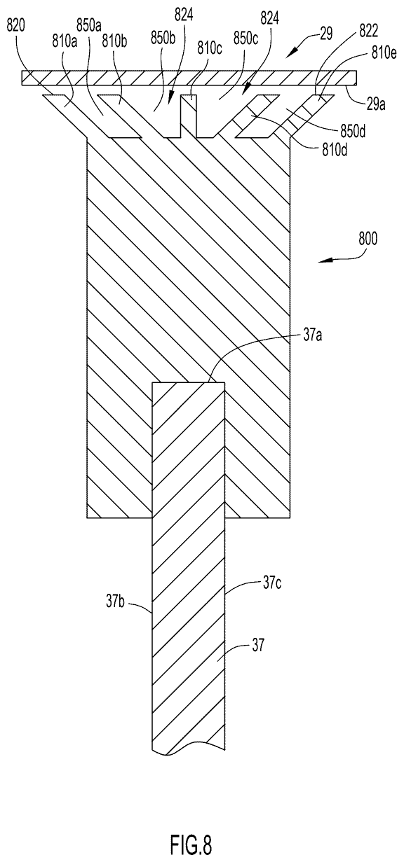

FIG. 8 illustrates a cross-sectional view of another flow restrictor 800 that is configured to induce one or more of fluid separation, fluid expansion loss, and/or fluid contraction loss to minimize leakage between adjacent zones of a RAM. Flow restrictor 800 functions similar to flow restrictors 600 and 700 and includes a plurality of walls 810a-e that includes first and second angled outermost walls 810a and 810e with walls 810b-d disposed therebetween. Formed between walls 810a-e is a plurality of grooves 850a-d. The plurality of grooves includes a first groove 850a positioned between the first angled outermost wall 810a and wall 810b, a second groove 850b positioned between walls 810b and 810c, a third groove 850c positioned between walls 810c and 810d, and a fourth groove 850d positioned between wall 810d and the second angled outermost wall 810e.

According to some implementations, each of walls 810a and 810b is angled outward in an oblique direction of the first side 37b of the radial plate 37 towards the first surface 29a of the sector plate 29, and each of walls 810d and 810e is angled outward in an oblique direction of the second side 37c of the radial plate 37 towards the first surface 29a of the sector plate 29. In the example of FIG. 8, the third wall 810c is arranged orthogonal to the first surface 29a of the sector plate 29. However, according to other implementations, each of walls 810b-d is arranged orthogonal to the first surface 29a of the sector plate 29.

According to some implementations, flow restrictor 800 is configured such that when a pressure on the first side 37b of the radial plate 37 is greater than a pressure on the second side 37c of the radial plate 37, a flow separation bubble (similar to that shown in FIG. 5B) is formed on a distal surface 820 of the first angled outermost wall 810a that faces the first surface 29a of the sector plate 29. According to some implementations, flow restrictor 800 is also configured such that when a pressure on the second side 37c of the radial plate 37 is greater than a pressure on the first side 37b of the radial plate 37, a flow separation bubble (not shown) is formed on a distal surface 822 of the second angled outermost wall 810e that faces the first surface 29a of the sector plate 29. The advantages associated with the formation of flow separation bubbles are discussed above.

According to some implementations, flow restrictor 800 is configured such that fluid flow expansion losses, like those discussed in conjunction with the example of FIGS. 5A and 5B, occur at an opening 824 of one or more of grooves 850a-d and fluid flow contraction losses occurs between one or more sets of adjacent grooves 850a-d, such as between grooves 850a and 850b, grooves 850b and 850c, and grooves 850c and 850d when there is a pressure differential between the first side 37b of the radial plate 37 and the second side 37c of the radial plate 37. Similarly, according to some implementations, flow restrictor 800 is configured such that fluid flow vortices (not shown) form inside one or more or all of grooves 850a-d when there is a pressure differential between the first side 37b of the radial plate 37 and the second side 37c of the radial plate 37. The formation of flow vortices inside one or more or all of the grooves 850a-d advantageously minimizes or impedes fluid flow across the width of the flow restrictor 800, such as by deflecting or otherwise reducing fluid flow advancing along the first surface 29a of the sector plate 29.

According to some implementations, any of flow restrictors 600, 700, or 800 is a unitary structure made from a single piece of material. According to some implementations, any of the flow restrictors 600, 700, or 800 are made of a polymeric material such as, for example PTFE and ethylene propylene diene monomer (EPDM). According to some implementations, the walls/extensions 610a-d, 710a-c, or 810a-e of any of the flow restrictors 600, 700, or 800 are rigid and are configured not to deform during normal operation of the RAM. This latter feature enables a more consistent production of flow separation bubbles, a more consistent production of flow expansion losses, and/or a more consistent production of flow contraction losses at the end portions of the flow restrictors 600, 700, or 800.

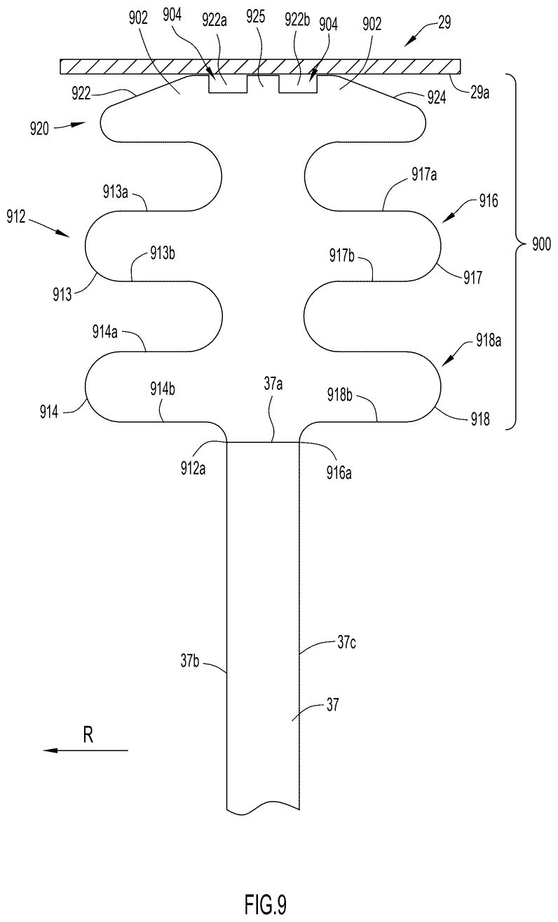

According to other implementations, minimizing or preventing fluid flow between the adjacent zones is achieved via a sealing member 900 that comprises a metallic spring assembly having first and second undulating side sections 912 and 916 that are arranged symmetrical to one another, as shown in FIG. 9. End portions 912a and 916a of the undulating side sections 912 and 916 are attached or coupled to the radial plate 37. A second end portion or extension 920 of the sealing member 900 is disposed between the undulating side sections 912 and 916. The undulating side sections 912 and 916 are configured to bias the second end portion 920 toward the sector plate 29 to press against the first surface 29a of the sector plate 29 when the second surface 37a of the radial plate 37 is aligned with the first surface 29a of the sector plate 29, thereby minimizing or preventing fluid flow between the adjacent zones. According to some implementations, the second end portion 920 includes leading and trailing ramp surfaces 922 and 924 that facilitate a smooth compression and decompression of the sealing member 900 as the sealing member 900 respectively approaches and moves away from the sector plate 29. When the second surface 37a of the radial plate 37 is aligned with the first surface 29a of the sector plate 29, at least a portion of the leading ramp surface 922 is located on the first side 37b of the radial plate 37 and at least a portion of the trailing ramp surface 924 is located on the second side 37c of the radial plate 37. The symmetric arrangement of the first and second undulating side sections 912 and 916 advantageously continuously urges the second end portion 920 of the sealing member 900 towards a vertical alignment with the radial plate 37.

As shown in FIG. 9, according to some implementations, the second end portion 920 of the sealing member 900 includes first and second of grooves 922a and 922b that are formed between walls 902 of the second end portion 920. Each of grooves 922a and 922b resides in an area between the leading and trailing ramp surfaces 922 and 924 and has an opening 904 that faces the first surface 29a of the sector plate 29. In the example of FIG. 9, the first and second grooves 922a and 922b are separated by a central wall 925 that is arranged orthogonal to the first surface 29a of the sector plate 29. In other implementations, the central wall may be arranged non-orthogonal to the first surface 29a. The purpose of grooves 922a and 922b is create fluid flow expansions, fluid flow contractions, and/or fluid flow vortices in the event that fluid flow is inadvertently established across the intended contact region of the second end portion 920 of the sealing member 900 with the first surface 29a of the sector plate 29. According to other implementations, the second end portion 920 of the sealing member 900 is devoid of grooves and may possess a flat or substantially flat surface that is configured to press against the first surface 29a of the sector plate 29.

According to some implementations, each of the first and second undulating side sections 912 and 916 has first protruding members or extensions 913 and 917 that have vertically spaced-apart surfaces 913a/913b and 917a/917b that each face towards the first surface 29a of the sector plate 29 when the second end portion 920 of the metallic spring assembly is pressed against the first surface 29a of the sector plate 29. According to some implementations, the first and second undulating side sections 912 and 916 additionally include second protruding members or extensions 914 and 918 that are respectively vertically spaced-apart from and located between the radial plate 37 and the first protruding members 913 and 917. The second protruding members 914 and 918 have vertically spaced-apart surfaces 914a/914b and 918a/918b that each face towards the first surface 29a of the sector plate 29 when the second end portion 920 of the sealing member 900 is pressed against the first surface 29a of the sector plate 29.

According to some implementations, surfaces 913a-b, 914a-b, 917a-b, and 918a-b of the protruding members 913, 914, 917, and 918 are each arranged parallel or substantially parallel (within ±15 degrees of parallel) to the first surface 29a of the sector plate 29 when the second surface 37a of the radial plate 37 is aligned with the first surface 29a of the sector plate 29. According to some implementations, the sealing member 900 is a unitary structure being made from a single piece of metal.

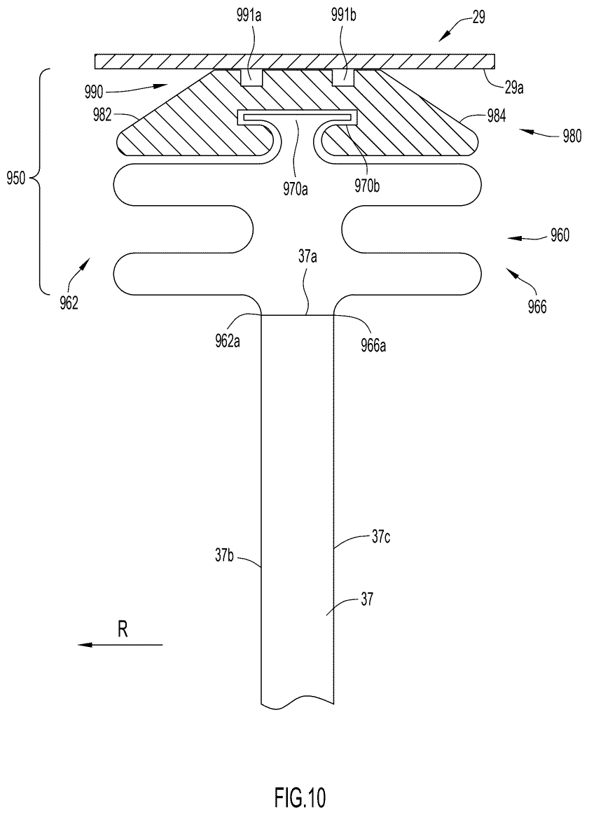

According to other implementations, the minimizing or prevention of fluid flow between the adjacent zones is achieved through the use of a sealing member 950 that includes a metallic spring assembly 960 and a non-spring element 980 like that shown in FIG. 10. According to some implementations, the metallic spring assembly 960 is a unitary structure being made from a single piece of metal and the non-spring element 980 is also a unitary structure that is made from another single piece of material (e.g., a polymeric material).

The metallic spring assembly 960 includes first and second undulating side sections 962 and 966 that are arranged symmetrical to one another and that are respectively similar in shape and function to the first and second undulating side sections 912 and 916 described above in conjunction with the example of FIG. 9. End portions 962a and 966a of the undulating side sections 962 and 966 are attached or coupled to the radial plate 37. As shown in FIG. 10, a proximal end portion of the non-spring element 980 is coupled to and supported by the metallic spring assembly 960. The metallic spring assembly 960 biases the non-spring element 980 toward the sector plate 29 to press a distal end portion or extension 990 of the non-spring element 980 against the first surface 29a of the sector plate 29 when the second surface 37a of the radial plate 37 is aligned with the first surface 29a of the sector plate 29. The non-spring element 980 includes leading and trailing ramp surfaces 982 and 984 that facilitate a smooth compression and decompression of the metallic spring assembly 960 as the sealing member 950 respectively approaches and moves away from the sector plate 29. When the first surface 29a of the radial plate 29 is aligned with the second surface 37a of the sector plate 37, at least a portion of the leading ramp surface 982 is located on the first side 37b of the radial plate 37 and at least a portion of the trailing ramp surface 984 is located on the second side 37c of the radial plate 37.

According to some implementations, the non-spring element 980 is made of a rigid material that does not deform when the surface of the distal end portion 990 is pressed against the first surface 29a of the sector plate 29. According to some implementations, the non-spring element 980 is a solid structure, whereas in other implementations, the non-spring element 980 is a hollow structure. The non-spring element 980 may be made of a material that is more wear resistant than the metallic spring assembly 960 and can be readily replaceable. Regarding the latter, as shown in the example of FIG. 10, attachment of the non-spring element 980 to the metallic spring assembly 960 can occur by sliding a non-circular shaped distal end protuberance 970a of the metallic spring assembly 960 into a mating slot 970b inside the non-spring element 980. In the example of FIG. 10, the non-spring element 980 is keyed to the metallic spring assembly 960 in a way that prevents or otherwise limits rotation of the non-spring element 980 with respect to the metallic spring assembly 960 to no more than ±10 degrees. The implementation of the non-spring element 980 may provide adequate sealing between the radial plate 37 and the sector plate 29 while increasing a useful lifespan of the sealing member 950.

According to some implementation, the distal end portion 990 of the non-spring element 980 includes first and second grooves 991a and 991b that are formed like and function like the grooves 922a and 922b described above in conjunction with the example of FIG. 9 (e.g., to create fluid flow expansions, fluid flow contractions, and/or fluid flow vortices in the event that fluid flow is inadvertently established across the intended contact region of the non-spring element 980 with the first surface 29a of the sector plate 29). However, according to other implementations, the distal end portion 990 is devoid of grooves and possesses a flat or substantially flat surface that is configured to press against the first surface 29a of the sector plate 29.

Each of the sealing members 501, 900, 950 and flow restrictors 600, 700 can be considered a flow restrictor or inhibitor that prevents or at least discourages fluid flow between the flow restrictor and a part (e.g., a plate) of a housing. In particular, the sealing members 501, 900, 950 are configured to abut the housing to inhibit fluid flow across the rotor, whereas the flow restrictors 600, 700 are configured to disrupt fluid flow across the housing to inhibit fluid flow across the housing.

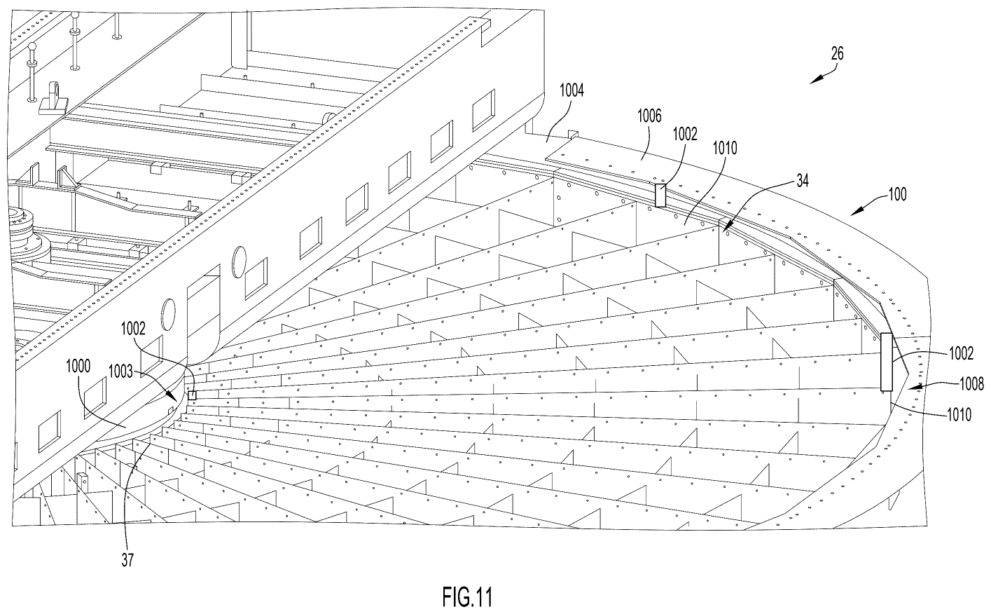

Additionally, any of the sealing members 501, 900, 950 and/or flow restrictors 600, 700 can be attached to a rotor (e.g., the rotor 34) in various manners to block undesirable fluid flow across or around the rotor, such as between adjacent zones. FIG. 11 illustrates one example by illustrating a portion of the RAM 26 in greater detail. The housing 100 of the RAM 26 includes an inner structure 1000 about which the rotor 34 rotates. For example, the inner structure 1000 may include a hub. The radial plates 37 of the rotor 34 extend radially outward from the inner structure 1000. A flow restrictor 1002 (e.g., any of the sealing members 501, 900, 950 and/or flow restrictors 600, 700) may be attached to a proximal end 1003 of at least one of the radial plates 37 to inhibit fluid flow between the radial plates 37 and the inner structure 1000. For example, the flow restrictor 1002 may contact (e.g., sealingly engage with) the inner structure 1000 and/or disrupt fluid flow between the rotor 34 and the inner structure 1000.

The housing 100 of the RAM 26 further includes an outer wall 1004 surrounding (e.g., circumferentially surrounding) a perimeter of the rotor 34. For instance, at least a portion of the outer wall 1004 may be positioned radially outward of the rotor 34 and/or may interconnect top and bottom sector plates of the RAM 26. In the depicted embodiment, the outer wall 1004 includes an outer plate 1006 extending in overlap with a portion of the rotor 34, such as a distal end of the radial plates 37. A flow restrictor 1002 may additionally or alternatively be coupled to the rotor 34 to inhibit fluid flow between the outer wall 1004 and the rotor 34.

As an example, a flow restrictor 1002 may be coupled to a distal end 1008 of at least one of the radial plates 37 of the rotor 34 and extend (e.g., axially extend) between the rotor 34 and the outer plate 1006. The flow restrictor 1002 may contact (e.g., sealingly engage with) the outer plate 1006 and/or disrupt fluid flow between the radial plates 37 and the outer plate 1006 to inhibit fluid flow between the radial plates 37 and the outer plate 1006. This may prevent or inhibit leakage between adjacent zones of the RAM 26 while also preventing or inhibiting circumferential leakage around a side of the rotor 34.

Furthermore, the rotor 34 includes distal plates 1010 attached to the distal end 1008 of the radial plates 37 and extending between adjacent radial plates 37. A flow restrictor 1002 may be coupled to one of the distal plates 1010 and extend (e.g., axially extend) between the rotor 34 and the outer plate 1006 to inhibit fluid flow between the rotor 34 and the outer plate 1006. Additionally or alternatively, the flow restrictor 1002 may be coupled to a dedicated component (e.g., a seal carrier bar) that is positioned outward of the distal plates 1010 to extend (e.g., axially extend) between the rotor 34 and the outer plate 1006 and inhibit fluid flow between the rotor 34 and the outer plate 1006. For example, in either case, the flow restrictor 1002 may contact (e.g., sealingly engage with) the outer plate 1006 and/or disrupt fluid flow between the distal plates 1010 and the outer plate 1006 to inhibit fluid flow between the distal plates 1010 and the outer plate 1006. Again, this may prevent or inhibit leakage between adjacent zones of the RAM 26 while also preventing or inhibiting circumferential leakage around a side of the rotor 34.

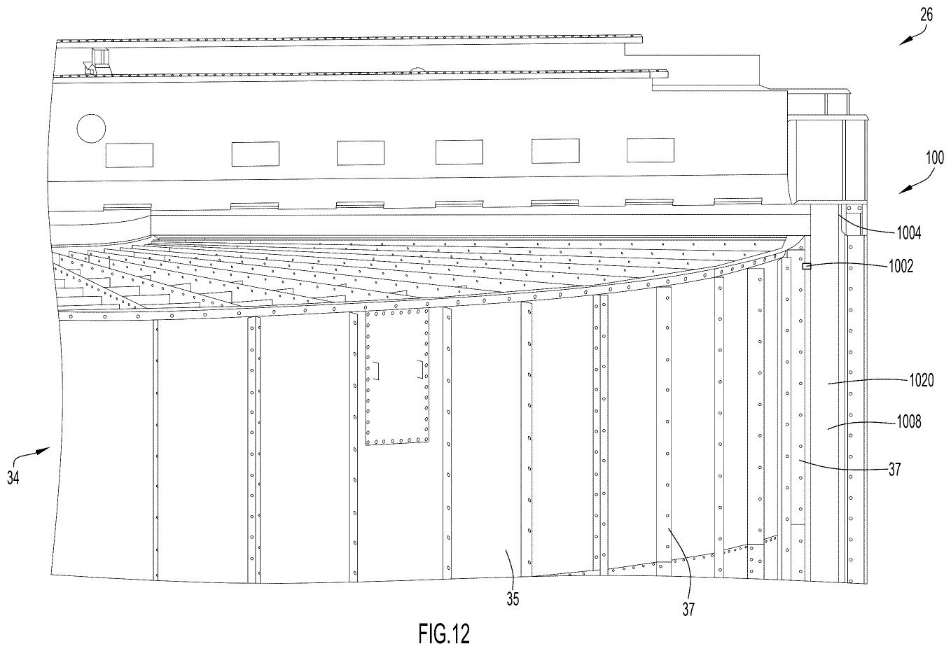

FIG. 12 illustrates another example of the implementation of the flow restrictor 1002 by illustrating another portion of the RAM 26 in greater detail. The housing 100 of the RAM 26 includes the outer wall 1004, which includes an axial plate 1020 positioned radially outward of the rotor 34, such as beyond a circumference of the rotor 34, between top and bottom sector plates, and/or extending along at least a portion of the outer shell 35 (e.g., a circumference of the outer shell 35) of the rotor 34. In the illustrated embodiment, the radial plates 37 of the rotor 34 and/or radially extending flanges extend radially beyond the outer shell 35 such that the distal end 1008 of a radial plate 37 or of a radially extending flange extends (e.g., radially extends) between the outer shell 35 and the axial plate 1020 when the radial plate 37 is aligned with the axial plate 1020. A flow restrictor 1002 may be attached to the distal end 1008 and contact (e.g., sealingly engage with) the outer plate 1006 and/or disrupt fluid flow between the radial plates 37 and the axial plate 1020 to inhibit fluid flow between the radial plates 37 and the axial plate 1020. Alternatively, flow restrictor(s) 1002 may be installed in similar locations even if the radial plates 37 do not protrude/extend as shown.

Overall, the RAM implementations provided herein achieve at least the advantages described herein. However, to be clear, while the application utilizes specific implementations to describe the RAM, as well as the advantages thereof, it is not intended to be limited to the details shown. Instead, it will be apparent that various modifications and structural changes may be made therein without departing from the scope of the inventions and within the scope and range of equivalents of the claims. In addition, various features from one of the implementations may be incorporated into another of the implementations.

It is also to be understood that the sector plate described herein, or portions thereof may be fabricated from any suitable material or combination of materials, such as metals or synthetic materials including, but not limited to, plastic, rubber, derivatives thereof, and combinations thereof. It is also intended that the present invention cover modifications and variations of this invention. For example, it is to be understood that terms such as “left”, “right”, “top”, “bottom”, “upper”, “lower”, “front”, “rear”, “side”, “height”, “length”, “width” “interior”, “exterior,” “inner”, “outer” and the like as may be used herein, merely describe points of reference and do not limit the present invention to any particular orientation or configuration.

Finally, when used herein, the term “comprises” and its derivations (such as “comprising”, etc.) should not be understood in an excluding sense, that is, these terms should not be interpreted as excluding the possibility that what is described and defined may include further elements, steps, etc. Meanwhile, when used herein, the term “approximately” and terms of its family (such as “approximate”, etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about” and “around” and “substantially”.

1. A rotary machine, comprising:
a rotor with a plurality of plates defining openings therebetween;
a housing enclosing the rotor; and
a flow restrictor comprising:
a body attached to a plate of the plurality of plates of the rotor and extending from the rotor toward the housing; and
a plurality of extensions extending from the body toward the housing to form a groove between extensions of the plurality of extensions.

2. The rotary machine of claim 1, wherein an extension of the plurality of extensions is configured to flex toward the housing in response to a pressure differential across the rotor to provide a seal against the housing.

3. The rotary machine of claim 1, wherein an extension of the plurality of extensions comprises:
an angled surface extending obliquely from the body toward the housing; and
a distal surface that is offset from the housing to form a gap between the housing and the extension, wherein the angled surface is configured to direct fluid flow toward the distal surface to deflect fluid flow advancing toward the gap.

4. The rotary machine of claim 1, wherein the plurality of extensions comprises a first extension extending obliquely from the body toward the housing and a second extension extending orthogonally toward the housing to form the groove between the first extension and the second extension, and the groove is configured to form fluid flow vortices to disrupt fluid flowing between the housing and the flow restrictor.

5. The rotary machine of claim 1, wherein the rotary machine comprises a plurality of zones, each zone of the plurality of zones is configured to receive a different fluid flow, the housing comprises a sector plate extending along a surface of the rotor between adjacent zones of the plurality of zones, and the flow restrictor extends between the plate of the plurality of plates of the rotor and the sector plate when the plate is in alignment with the sector plate.

6. The rotary machine of claim 1, wherein the rotary machine comprises an outer wall positioned radially beyond the rotor, and the flow restrictor extends between the plate of the plurality of plates of the rotor and the outer wall.

7. The rotary machine of claim 1, wherein the housing comprises an inner structure about which the rotor is configured to rotate, and the flow restrictor extends between the plate of the plurality of plates of the rotor and the inner structure.

8. The rotary machine of claim 1, wherein the body comprises a spring configured to bias the plurality of extensions toward the housing.

9. The rotary machine of claim 1, comprising adsorbent material disposed in the openings defined between the plurality of plates.

10. The rotary machine of claim 1, wherein the rotary machine comprises a rotary heat exchanger.

11. A flow restrictor for a rotary machine, the flow restrictor comprising:
a body configured to attach to a rotor of the rotary machine, the rotor comprising a plurality of plates, and the body being configured to attach to a plate of the plurality of plates; and
a plurality of extensions extending from the body toward a housing of the rotary machine to inhibit fluid flow between the housing and the plate.

12. The flow restrictor of claim 11, wherein an extension of the plurality of extensions is curved to form a convex surface facing the housing and a concave surface opposite the convex surface.

13. The flow restrictor of claim 11, wherein an extension of the plurality of extensions extends obliquely outward from the body toward the housing of the rotary machine.

14. The flow restrictor of claim 11, wherein the body comprises a spring configured to bias the plurality of extensions toward the housing.

15. The flow restrictor of claim 14, wherein the body and the plurality of extensions are separate components coupled to one another.

16. The flow restrictor of claim 15, wherein the body and the plurality of extensions are composed of different materials.

17. A flow restrictor of a rotary machine, the flow restrictor comprising:
a body configured to attach to opposite sides of a plate of a rotor of the rotary machine; and
an extension extending from a distal end of the body, wherein the extension is configured to flex toward a housing of the rotary machine in response to a pressure differential across the rotor to provide a seal against the housing.

18. The flow restrictor of claim 17, wherein the extension extends from the body in a direction of rotation of the rotor.

19. The flow restrictor of claim 18, comprising an additional extension extending from the distal end of the body in an opposite direction of rotation of the rotor, wherein the extension and the additional extension form a groove therebetween.

20. The flow restrictor of claim 17, wherein the extension is curved to form a concave surface facing the body and a convex surface facing away from the body.
